(19) United States
(12) Patent Application Publication
(10) Pub. No.: US 2005/0197960 A1
(43) Pub. Date: Sep. 8, 2005

(54) System and method for renting or purchasing and viewing moving digital images

(76) Inventors: Wolfgang Daum, Groton, MA (US); Lucy Elandjian, Groton, MA (US)

Correspondence Address: LUCY ELANDJIAN, COUNSELLOR AT LAW, 4 LONGFELLOW PLACE, SUITE 3209, BOSTON, MA, 02114, US

(21) Appl. No.: 11/043,829

(22) Filed: Jan. 26, 2005

Related U.S. Application Data
(60) Provisional application No. 60/539,373, filed on Jan. 27, 2004.

(51) Int. Cl. G06F 17/60

(52) U.S. Cl. 705/52

(57) ABSTRACT

Disclosed is a system for renting or purchasing and viewing moving digital images, such as movies, entertainment or sporting events, via a wireless telephony device, such as a mobile phone, a personal communication system, Blackberry® or a Bluetooth® device. Also disclosed are methods for renting or purchasing and viewing moving digital images, and for making payments for said rentals or purchases.

### CROSS REFERENCE TO RELATED APPLICATION

This is a non-provisional application claiming the benefit of and priority to provisional patent application Ser. No. 60/539,373 filed on Jan. 27, 2004, which is incorporated by reference.

### TECHNICAL FIELD

The present invention relates to a system and methods for renting or purchasing and viewing moving digital images, such as movies, via a wireless telephony device, such as a mobile phone, a personal communication system, a Blackberry® or a Bluetooth® device.

### BACKGROUND

Currently, there are over 150 million wireless telephone subscribers in the USA. Wireless telephony devices, such as mobile phones, personal communication systems, Blackberry® and Bluetooth® devices are becoming more and more advanced, and such devices with built-in screens for viewing photographs are becoming more commonplace.

There are various methods for renting or purchasing movies or entertainment events on the market. Some of these models include rental or purchase of a hardcopy, such as a DVD or a VHS videotape, by a customer, or rental of a softcopy, such as delivery of a movie or entertainment event via cable television by a customer through the customer's television set or via the internet.

Currently, no method exists in which a movie or an entertainment or sporting event can be rented or purchased via a wireless telephony device for viewing it on the display screen of a wireless telephony device at anytime or at anyplace of one's choosing.

### SUMMARY OF THE INVENTION

Although methods exist for renting movies or entertainment events, whether in hard copy or soft copy form, these methods do not accommodate the rental or purchase and viewing of movies via wireless telephony devices.

In view of the above, there is a need for a means of renting or purchasing and viewing moving digital images, such as movies and entertainment events, via wireless telephony devices.

It is, therefore, an aspect of the present invention to provide a system for the rental or purchase of moving digital images, such as movies, via wireless telephony devices.

It is also an aspect of the present invention to provide a method for renting or purchasing moving digital images, such as movies, via wireless telephony devices.

It is also an aspect of the present invention to provide a method of payment for the rental or purchase of the moving digital images.

The present invention pertains to a system for renting or purchasing and viewing moving digital images, and methods related thereto. The system involves a telephony network, and a wireless telephony device having a screen capable of displaying moving digital images. The system may further comprise a memory device for storage of the moving digital images, an analog or digital moving digital image read-out device which generates image signals, a converter which transmits the signals through the telephony network to the wireless telephony device, or any combination thereof.

The methods of the present invention involve renting or purchasing moving digital images via wireless telephony devices. A requester selects and orders an item of moving digital images from a provider of moving digital images, and the provider transmits the selected item to the requester's wireless telephony device, which is equipped with a screen capable of displaying moving digital images, via a telephony network. The item of moving digital images is then displayed on screen of the wireless telephony device. The provider may transmit a list of items of moving digital images to the requester's wireless telephony device to facilitate the requester's selection. The requester may also access such a list from a published media source. The item of moving digital images may be ordered using a wireless or wired telephony device, or via the internet. The telephony network may comprise wireless connections, or a combination of wired and wireless connections. The moving digital images may be viewed once or multiple times and in entirety or in portions. The moving digital images may be stored in the memory of the wireless telephony device, either for short-term or for long-term.

The present invention also pertains to payment systems for the rental or purchase of the moving digital images. The payment systems may comprise the establishment of an account or a contract with a provider of digital images, a wireless network company, or both.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates the connection between a customer and a provider of moving digital images via a telephony network which comprises a combination of wired and wireless connections, according to one embodiment of the present invention; and

FIG. 2 schematically illustrates the connection between a customer and a provider of moving digital images via a wireless telephony network, according to one embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF EXEMPLARY EMBODIMENTS

The present invention pertains to a system for renting or purchasing and viewing moving digital images via wireless telephony devices, and methods related thereto. The system involves a telephony network, and a wireless telephony device having a screen capable of displaying moving digital images. The system may further comprise a memory device for storage of the moving digital images, an analog or digital moving digital image read-out device which generates image signals, a converter which transmits the signals through the telephony network to the wireless telephony device, or a combination thereof.

The methods involve a requester, for example, a customer, selecting and ordering an item of moving digital images from a provider of moving digital images, and the provider transmitting, via a-telephony network, the selected item to the requester's wireless telephony device, which is equipped with a screen capable of displaying moving digital images. The item of moving digital images is then displayed on screen of the wireless telephony device. The customer can view the moving digital images once or multiple times and in entirety or in portions.

1. Definitions

The terms “wireless telephony device”, “mobile phone”, “cellular phone”, “personal communication system” (PCS), “Blackberry® device” or “Bluetooth® device”, as used herein, refer to and describe a radio frequency receiving wireless telephony device having a screen, which may be built-in to or otherwise associated with the telephony device, on which information or moving digital images can be displayed.

The term “moving digital images”, as used herein, refers to a movie, a film, an entertainment or sporting event, and the like which can be displayed on the screen of a wireless telephony device.

The term “radio frequency”, as used herein, refers to a band within the kilohertz, megahertz, or gigahertz region of the electromagnetic spectrum.

The terms “requester” and “customer”, as used herein, refer to and describe a person or entity who rents or purchases moving digital images.

The term “provider”, as used herein, refers to and describes a person or entity that provides moving digital images via a telephony network to a wireless telephony device. The provider of moving digital images may also be the wireless network company in one embodiment of the present invention, while in other embodiments the two entities are separate and distinct, and while in other embodiments the two entities may be separate but related to each other.

The terms “screen” and “display”, as used herein, refer to means for optically presenting information on a wireless telephony device such as thin-film-transistor (TFT) units, liquid crystal display (LCD) units, or nano emissive displays (NED). The screen may display the information in color or in black-and-white. The screen or display may be built-in to the wireless telephony device.

The term “telephony”, as used herein, refers to the process of converting sounds or images into electrical impulses for transmission over a connecting medium such as wires, fiber optics, or electromagnetic airwaves in the radio frequency region.

The term “telephony network”, as used herein, refers to network of communication devices, such as telephones and computers, which may comprise standard telephony, IP telephony, or a combination thereof. The telephony network may be entirely wireless or may be a combination of wired and wireless connections through which digital image signals are transmitted to wired or wireless telephony devices. The telephony network provides voice and data communication over a circuit-switched network. IP telephony (IPTel) refers to the transport of voice, video, text, and other real-time media over IP networks. The IP telephony is based on the concept that, rather than using dedicated circuits between each party on a phone conversation, audio can be compressed and transmitted over an IP-based network in small packets. This reduces the cost of the equipment and the amount of resources required for making telephone calls. In addition, by using a packet-based network such as IPTel, communication can be extended beyond voice telephone calls.

The term “wireless”, as used herein, refers to communication or transmission that occurs via optical or electromagnetic airwaves versus communication or transmission via cables or land-telephone lines. Specifically, wireless communication is enabled by packet radio, spread spectrum, cellular technology, satellites, and microwave towers, and it can be used for transmission of voice, data, video, images, or any combination thereof.

The terms “wireless platform” or “wireless network”, as used-herein, refer to a network that transmits information over electromagnetic airwaves. The signal transmissions actually occur through air rather than through copper or fiber-optic cables. A network is a collection of two or more devices, such as computers, telephones, and communication devices, that are linked together with communications equipment. Once connected, each part or device of the network can share information with other parts or devices. All wireless networks transfer the information via electromagnetic airwaves in the radio frequency region of the electromagnetic spectrum. Devices of a network can operate in analog or digital format.

The term “Blackberry®” or “Bluetooth®”, as used herein, refers to an open wireless technology specification that enables low-bandwidth, short-range wireless connections between mobile devices, computers and peripherals, such as mice, cellular phones, and personal data assistants (PDAs). Blackberry® and Bluetooth® are networking technologies that enable data to easily transfer from one device to another using radio frequency.

It is to be understood that the singular forms of “a”, “an”, and “the”, as used herein and in the appended claims, include plural reference unless the context clearly dictates otherwise.

2. System for Renting or Purchasing of Moving Digital Images

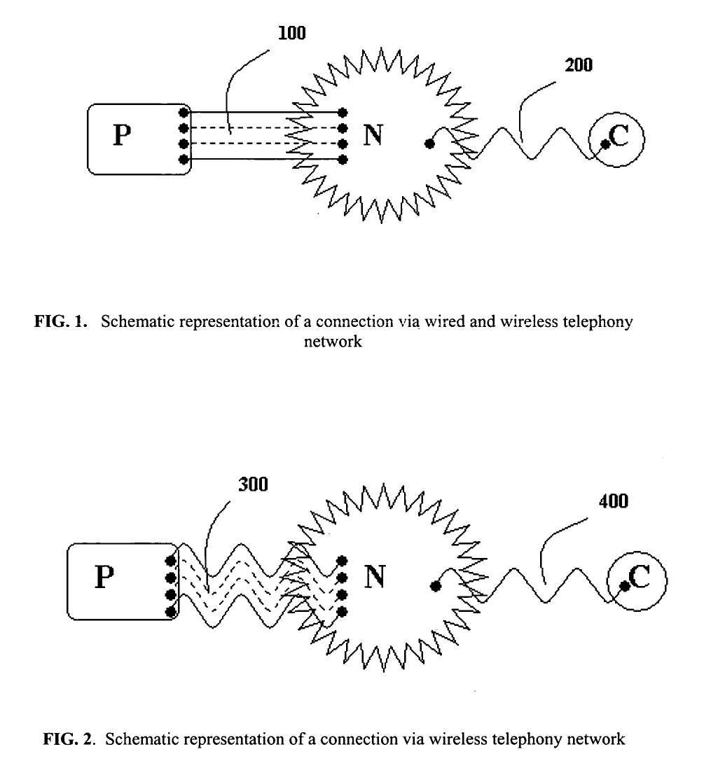

FIG. 1 illustrates an embodiment of the system of the present invention in which provider P is connected with one or more wired telephone lines 100 to a telephony network N, and customer C is connected to the telephony network N via a wireless telephony device 200. FIG. 2 illustrates an embodiment in which provider P is connected to the telephony network N via wireless telephony device 300, and customer C is connected to the telephony network N via wireless telephony device 400. The telephony network N may be entirely wireless, or it may comprise wired and wireless connections.

The system of the present invention comprises, a) on the provider's side, a telephone line (wired or wireless) capable of establishing connection with a telephony network, and may further comprise a memory device for storage of the moving digital images, an analog or digital moving digital image read-out device, which displays the moving digital images and transmits the moving digital image signals, a converter, which converts the analog or digital image signal to a telephone signal standard, or any combination thereof; b) a telephony network, which may be entirely wireless or may be a combination of wired and wireless connections through which the digital image signals are transmitted to wireless telephony devices; c) on the requester's side, one or more wireless telephony devices capable of receiving, optionally storing, displaying the moving digital images, or any combination thereof.

The memory device for storage of the moving digital images can be, is not limited to, a digital video disk (DVD) or video cassette (e.g., VHS) player, a data file on a hard drive, or a data file on a solid state memory chip. The read-out device can be, but is not limited to, a DVD or video cassette player, a hard drive, or an electronic circuit board.

The wireless platform or wireless network for use herein can be, but is not limited to, CDPD (cellular digital packed data), CDMA (including CDMA2000, etc.) (Code-Division Multiple Access), GSM (Global System for Mobile Communications), TDMA (Time Division Multiple Access), or GRPS (General Packet Radio Service).

The wireless telephone signal standard for use herein can be, but is not limited to, GSM-900 (Global Standard for Mobile Communication), GSM-1800, GSM-1900, CDMA IS-95, TDMA IS-136, 3G systems—IMT-2000, WAP (Wireless Application Protocol), UMTS (Universal Mobile Telecommunication System), WML (Wireless Markup Language), HTML (Hypertext Markup Language), MPEG (Motion Picture Experts Group), PCS (Personal Communication System), Bluetooth®, any other industry accepted standard, or any combination thereof. The applications may be programmed in JAVA®, J2ME, J2EE, or other subgroups of JAVA®.

3. Method for Renting or Purchasing of Moving Digital Images

The methods of the present invention generally comprise:
1. a requester of moving digital images contacts a provider of moving digital images to place an order for the rental or purchase of moving digital images;
2. the provider of moving digital images transmits the ordered moving digital images to the requester's wireless telephony device via a telephony network; and,
3. the moving digital images are accessed for viewing on the display screen of the wireless telephony device.

The telephony network may be entirely wireless or may be a combination of wired and wireless connections. The requester has an existing or establishes a contract and/or account with the provider of moving digital images, a wireless network company, or both.

In one embodiment of the present invention involving the method of renting or purchasing and viewing moving digital images, a requester, for example a customer, contacts the provider of moving digital images with a wireless telephony device. The provider transmits a list containing one or more items of moving digital images via a telephony network to the customer's wireless telephony device; the list arrives and is displayed on the screen of customer's wireless telephony device. The list contains one or more items of moving digital images, such as movies, with identifying information for each item, a code for each item, or both. The code can be one or more digits, and it can be numeric, alphabetical, or alpha-numeric. The customer selects an item of moving digital images, e.g., a movie, by entering the identifying information or code of the item into the keypad of the wireless telephony device. The entry may be followed or preceded by a symbol, such as # (number or pound sign) or * (asterisk). Alternatively, the customer may bypass the list retrieval step by entering the identifying information or code of the movie, which the customer may have due to prior transmitted lists, or from publications in a source of media. The provider transmits the selected movie as signals, and the customer receives and views the movie on the screen of the wireless telephony device.

The customer may end the telephonic connection at any time, during or after the end of the movie transmission. Alternatively, the customer may continue to remain connected after the end of the movie to request another list, or select and optionally view another movie. Alternatively, the customer may choose to end the transmission before the end of the movie and call back at a later time and/or day to view the remaining/unviewed portion of the movie. Alternatively, the customer may view the entire movie at that time, but call back at another time within a given period, e.g., twenty-four hours, to view it again in its entirety or a portion thereof.

The customer is charged an amount of money per unit of time for the duration of the telephony connection. Thus, if a customer maintains the telephony connection for the period of time in which the entire movie is transmitted, which may be, for example ninety minutes and the customer's rental rate may be $0.02/minute, the customer is charged $1.80 for the service. Alternatively, the customer is charged a fixed fee for the movie, for example, $2.50, regardless of the duration of the transmission time. A grace period of certain period of time at the beginning of the transmission of the movie may be available to the customer. During such a grace period, the customer may end the telephony transmission without being charged for the movie or transmission time. In an embodiment where the customer pays a fixed fee for the movie, the customer may have a time restriction in which to call back to view the entire movie or any portion thereof without being charged again, for example, twenty-four hours. In an embodiment where the customer is charged based on the per unit of time of transmission, the re-establishment of the telephony connection to view remaining/unviewed portions or the entire movie would again cost the customer an amount of money per unit of time of transmission.

In another embodiment of the methods of the present invention, a customer contacts the provider of moving digital images with a wireless telephony device. The provider transmits a list of moving digital images, such as movies, via a telephony network to the customer; the list arrives and is displayed on the screen of the customer's wireless telephony device. The list contains one or more items of moving digital images, such as movies, with identifying information and a different telephone number corresponding to each movie. The customer ends this transmission (the “list transmission”) and initiates, via the wireless telephony device, a new telephonic transmission (the “selection transmission”) to place an order for the movie by calling the telephone number corresponding to the selected movie. The customer may initiate the selection transmission immediately after the end of the list transmission or a period of time thereafter. Alternatively, the customer may contact the provider via a wired telephony device or via the internet to place the order for the movie. The provider transmits the selected movie (“movie transmission”) to the customer's wireless telephony device. The customer receives the movie and views it, entirety or a portion thereof, on the display screen of the wireless telephony device. Alternatively, the customer may view a portion or the entire movie at that time, but call back at another time within a given period, e.g., twenty-four hours, to view it again in its entirety or a portion thereof. The customer may end the telephonic connection at any time, during or after the end of the movie transmission.

As disclosed above, the customer is charged an amount of money per unit of time for the duration of the telephony connection, both for the list and the movie transmissions. The rate at which the customer is charged may be the same or different for the list and the movie transmissions. Alternatively, the customer is charged a fixed fee per movie regardless of the duration of the transmission time. Alternatively, movies are scheduled for transmission only at certain times, and the customer can call and establish connection only at the scheduled time or time periods. In such situations, the schedule of the movies may also be transmitted and displayed in the list along with the identifying information of the movie and its corresponding phone number. The list containing the identifying information, phone numbers and schedules can also be published in any other media, such as newspaper, internet, television, radio, bulletin boards, etc. A customer having access to a list so published may not need to initiate a transmission via the wireless telephony device to obtain the information to facilitate the selection of the movie.

In another embodiment of the methods of the present invention, a customer establishes a telephony connection with the provider of moving digital images using a wireless telephony device. The provider transmits a list containing one or more items of moving digital images, such as movies, to the customer, via a telephony network; the list is displayed on the screen of customer's wireless telephony device. Each movie has identifying information, a corresponding code, or both. The customer selects a movie to rent or purchase by entering the identifying information or code of the desired movie into the keypad of the wireless telephony device. The entry may be followed or preceded by a symbol, such as (number or pound sign) or * (asterisk). The customer may need to make a further entry to designate the selection as a rental or a purchase. Alternatively, the code may include a designation to reflect the availability of the movie as a rental or as a purchase.

The provider transmits the movie, via a telephony network, as a data file to the customer's wireless telephony device. The movie is stored upon receipt in the memory of the wireless telephony device. The customer may be permitted to store the movie temporarily or for a short duration, which would equate to rental of the movie, or permanently or for a long duration, which would equate to purchase of the movie. The ability to store the movie provides the customer with a greater flexibility to view the movie at any day or time, or to view it multiple times. The cost of the movie for which the customer is charged depends on whether the movie is purchased or rented.

In another embodiment of the methods of the present invention, a customer establishes a telephonic connection with the provider of the moving digital images using a wireless telephony device. The provider transmits a list containing one or more items of moving digital images, such as movies, to the customer, via a telephony network; the list is displayed on the screen of the customer's wireless telephony device. The list contains each movie's identifying information, corresponding code and transmission schedule, particularly the date and time of transmission options. The customer selects a movie to rent or purchase by entering the requisite codes of the desired movie into the keypad of the wireless telephony device. The entry of the identifier codes may be followed or preceded by a symbol, such as # (number or pound sign) or * (asterisk). The customer may need to make a further entry to designate the selection as a rental or a purchase. Alternatively, the identifier code may include a designation to reflect the availability of the movie as a rental or as a purchase. Alternatively, the customer may be offered the option to designate the order for the movie as a rental or a purchase immediately before or after the transmission of the movie. The customer ends the telephonic connection with the provider. The provider then contacts the customer via the customer's wireless telephony device at a defined day and time and transmits the selected movie. If the customer has selected more than one movie, then the provider contacts the customer at each defined day and time to transmit the ordered movies.

The customer can view the movie as it is being transmitted. The customer is charged either a fixed fee for the movie, or a fee based on an amount of money per unit of time of transmission, depending on the customer's request. This request may be established each time a movie is ordered, or at the time of account establishment with the provider. However, the customer may change the status of the structure at any time after the establishment of the account.

Alternatively, the customer stores the transmitted movie, which may be transmitted as a data file, in the memory of the wireless telephony device, and views it at another day and/or time. If the customer has selected the rental option, then the customer can store the movie temporarily or for a short duration, and if the customer has selected the purchase option, then the customer can store the movie permanently or for a long duration. The customer is charged a fee depending on the status of the selection being a rental or a purchase. The option to rent or purchase a movie may be established each time a movie is ordered, or at the time of account establishment with the provider. If the customer has made this selection at the time of account establishment, the customer may change the status of this selection at any time thereafter.

In another embodiment of the methods of the present invention, a customer establishes an order for moving digital images from a provider. The customer may place this order using a wireless or wired telephony device, or via the internet. The order process comprises the instructions for transmission of the moving digital images to the customer's wireless telephony device. Alternatively, the customer's instructions for the transmission as well as the customer's identifying information and/or password are supplied to the provider at the time of account establishment, and the customer's entry into the provider's system automatically instructs the provider to transmit the ordered items of moving digital images to the customer's wireless telephony device. The order specifies the time, and day of the week, month, year, or any combination thereof for the transmission of moving digital images from the provider to the customer's wireless telephony device. The order may specify the particular item of moving digital images, or only specify a category of moving digital images, such as movies, or subcategories thereof, e.g., comedies, mysteries, and horror movies, or any new releases, sporting events, or subcategories thereof, e.g., boxing events and Olympic events, or entertainment events, e.g., concerts or comedy shows, a combination of categories, or a combination of one or more items of particular moving digital images and one or more categories or subcategories. Then, on the scheduled day and time, the provider transmits the moving digital images, via signals or data files, through the telephony network to the customer's wireless telephony network.

The customer is charged and billed for each item of moving digital images prior to, during or at the completion of the transmission or at the beginning or the end of an agreed upon period for all moving digital images transmitted, such as a week or a month. The amount of fee that a customer is charged depends of whether the order was for the rental or the purchase of the moving digital images. The customer may be charged a fixed fee for each item of moving digital images ordered and received, or a fixed fee for a given period of time, such as a week, during which a customer may order and receive a limited or unlimited number of transmissions of moving digital images. Alternatively, the customer may be charged and billed for a period of time per transmission prior to, during or at the end of each transmission, or at the beginning or end of an agreed upon period of time for all the moving digital images transmitted, such as a week or a month. The customer may be charged this fee for each item of moving digital images ordered and received, or a fixed fee for a given quantity of time, such as five or ten hours of transmission ordered and received. The various fixed fee billing situations may alternatively involve the prepayment of the fixed fee at the start of the time period. The fixed fee billing situations may alternatively involve repetitive billing of the fee on an agreed upon day and/or time at the beginning or end of an established cycle or period of time.

In one embodiment of the methods of the present invention, a customer may transfer the moving digital images from the wireless telephony device to another wireless telephony device, to a DVD, to the hard disk of a computer, or to a mobile digital viewing device, such as an MP3 player-like device equipped with a display screen and capable of receiving and storing the moving digital images.

In any of these methods, the wireless telephony device may be equipped with a special electronic component or software component, that allows the customer to view the particular moving digital images, such as a particular movie, only once, allows the customer to store the movie only for a limited amount of time, or does not allow the customer to store the movie. The provider may choose to transmit moving digital images to a customer only upon checking (this may be possible automatically) and confirming that the customer's wireless telephony device has such a component installed and it is in working condition. In any of these disclosed methods, the provider may rent an item of moving digital images only after a customer has agreed in advance, such as at the time of establishing an account with the provider, to not store the item or store it for only the agreed upon limited amount of time.

The methods of the present invention may also comprise the establishment and use of a password by the customer to access the provider's database or system or to receive the transmission. Alternatively, an electronic and/or wireless signature may be required for access to the provider's database or system, to approve the order, to accept transmission, to confirm the receipt of transmission, to approve the charge or payment for the item, or any combination thereof.

4. Payment Methods for the Rental or Purchase of Moving Digital Images

The customer may establish an account with the provider of moving digital images for the rental and/or purchase of moving digital images. The customer may also establish an account with a wireless network company. The provider of digital images or the wireless network company may check the credit history and credit worthiness of the customer during this process.

4.1. Customer Pays the Wireless Network Company

During or after establishing the account with the wireless network company, the customer may agree to pay the wireless network company (e.g., on a monthly, biweekly, or weekly basis) the fees charged by the provider of moving digital images, and the wireless network company pays the provider the amount it collects from the customer. The wireless network company may charge a fee for this service, which may be assessed to the customer, the provider, or divided between both parties. The charges appear on the customer's bill from the wireless network company. Customer may elect to pay the wireless network company with a credit card, debit card, pre-paid card, gift card, check, electronic money transfer, pre-paid account, or any other acceptable means of payment.

4.2. Customer Pays Provider of Moving Digital Images

The provider of moving digital images bills the customer directly. The billing is established on an agreed cycle of time, as disclosed above. The billing and/or payment may be at the beginning or the end of a transmission (on demand upon delivery of moving digital images), at the beginning or the end of an agreed period of time, such as quarterly, monthly, biweekly weekly, or weekly. The charges appear on the customer's bill from the provider of moving digital images. The customer may elect to pay the provider with a credit card, debit card, pre-paid card, gift card, check, electronic money transfer, pre-paid account, or any other acceptable means of payment.

As noted above, the present invention is applicable to systems for renting or purchasing, and viewing moving digital images via wireless telephony devices, and methods related thereto. The present invention should not be considered limited to the particular embodiments described above, but rather should be understood to cover all aspects of the invention as fairly set out in the appended claims. Various modifications, equivalent processes, as well as numerous structures to which the present invention may be applicable will be readily apparent to those skilled in the art to which the present invention is directed upon review of the present specification. The claims are intended to cover such modifications and devices.

1. A system for renting or purchasing one or more items of moving digital images, comprising a telephony network, and a wireless telephony device equipped with a screen capable of displaying moving digital images.

2. A system according to claim 1, further comprising a memory device for storage of the moving digital images, an analog or digital moving digital image read-out device which generates image signals, a converter which converts the image signals to a telephony signal standard; and, a telephony network, for transmitting the signals to the wireless telephony device, or a combination thereof, and wherein the telephony network comprises wireless connections, or a combination of wired and wireless connections.

3. A method for renting or purchasing moving digital images, comprising:
a. a requester of moving digital images contacting a provider of moving digital images to place an order for the rental or purchase of moving digital images;
b. the provider of moving digital images transmitting the ordered moving digital images to a wireless telephony device designated by the requester; and
c. accessing of the moving digital images for viewing on the display screen of the wireless telephony device.

4. A method according to claim 3, further comprising the provider transmitting a list of items of moving digital images for rent or sale.

5. A method according to claim 4, wherein the requester selects at least one item of moving digital images from the list transmitted by the provider.

6. A method according to claim 3, further comprising the requester selecting at least one item of moving digital images from a list published in a media source.

7. A method according to claim 3, further comprising the requester placing the order via a wireless or wired telephony device or via the internet.

8. A method according to claim 7, wherein the requester places the order by entering identifying information, a code, or a combination thereof corresponding to each item of moving digital images into the keypad of the telephony device or an internet device.

9. A method according to claim 3, further comprising the requester establishing a different telephonic connection to place an order for each item of moving digital images.

10. A method according to claim 7, wherein the requester designates each item on the order as a rental or a purchase.

11. A method according to claim 7, wherein the requester selects the date and time of transmission for each item in the order.

12. A method according to claim 3, wherein the moving digital images are transmitted as telephone signals or data packets.

13. A method according to claim 12, wherein the moving digital images are stored short term or long term in the wireless telephony device.

14. A method according to claim 3, wherein the requester views the item of moving digital images in portions at different times.

15. A method according to claim 3, wherein the requester views multiple times a portion or the entire item of moving digital images.

16. A method according to claim 3, wherein the requester places an order for multiple items of moving digital images, and wherein the multiple items of moving digital images may be transmitted by provider in one transmission or in multiple transmissions at different times.

17. A method according to claim 3, further comprising the provider charging the requester a fixed fee or a fee based on an amount of money per unit of time of transmission for the rental or purchase of the moving digital images.

18. A method according to claim 17, further comprising the requester paying for the rental or purchase of the moving digital images.

19. A method according to claim 3, wherein the moving digital images is a movie, a film, or an entertainment or sporting event.

20. A method according to claim 3, wherein the moving digital images are transferred from the wireless telephony device to another wireless telephony device, to a digital video disk, to the hard disk of a computer, to a memory chip, or to a mobile digital viewing device.
